(19) United States
(12) Patent Application Publication
(10) Pub. No.: US 2024/0337140 A1
(43) Pub. Date: Oct. 10, 2024

(54) Concealed Door Handle Assembly

(71) Applicant: Illinois Tool Works Inc., Glenview, IL (US)

(72) Inventors: Nidhin KUNIYIL, Maharashtra (IN); Virupaxi PAYANNAVAR, Maharashtra (IN)

(21) Appl. No.: 18/616,479

(22) Filed: Mar. 26, 2024

(30) Foreign Application Priority Data
Apr. 7, 2023 (IN) 202311026233

(51) Int. Cl. E05B 85/10; E05B 81/76

(52) U.S. Cl. CPC E05B 85/107; E05B 81/76; E05B 85/103

(57) ABSTRACT

Disclosed is a concealed door handle assembly (100). The concealed door handle assembly (100) includes a housing (106), a door lock access (200), a lockable push-push mechanism (108) and a door operation assembly (300). The door lock access is mounted on the housing (106) and is selectively accessible. The lockable push-push mechanism (108) is operably mounted on the housing (106). A door operation assembly (300) operably mounted on the housing (106) comprises, a locking mechanism in an operable connection with the door lock access (200) to initiate locking action, a latching mechanism to initiate a latching action. The door handle (104) pivotably connected to the housing (106) about a door handle axis parallel to a plane of the housing (106) for the door handle (104) to conceal access to the door lock access.

### RELATED APPLICATION

The present application claims the benefit of Indian Patent Application Nos. 202311026233, filed Apr. 7, 2023, titled “Concealed Door Handle Assembly,” the contents of which are hereby incorporated by reference.

### BACKGROUND

A door operation assembly generally includes a door locking mechanism and a door handle assembly. The door locking mechanism is, generally, used to lock the door to prevent access to the vehicle, while the door handle assembly is, generally, used in vehicles to de-latch the door once the door locking mechanism is in an unlocked state. For an aesthetic appeal of exteriors, nowadays, vehicles are provided with flush door handle assemblies. Such a door handle assembly includes a handle that is retractably mounted to the vehicle door such that the handle is flush with a metal door of the vehicle door, for example, the exterior of the vehicle, when not in use or undeployed. The handle may be movable between an undeployed or flush position and a deployed position. In the deployed position, the handle protrudes from the side wall for being pulled by a user to open the vehicle door or for de-latching the vehicle door. In other words, the vehicle door is de-latched when the user further pulls the handle from the deployed position.

### SUMMARY

The present disclosure relates generally to a concealed door handle assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a door accommodating a concealed door handle assembly, according to an example of the present subject matter.

FIG. 2A illustrates the concealed door handle assembly in a flush position, according to an example of the present subject matter.

FIG. 2B illustrates the concealed door handle assembly in a deployed position, according to an example of the present subject matter.

FIG. 3 illustrates a perspective view of the concealed door handle assembly in the door, according to an example of the present subject matter.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A door operation assembly includes a door locking mechanism and a door handle assembly. Conventional door handle assemblies, that are deployed in vehicle doors may be mechanically or electrically actuated for moving the door handle, in which the door handle is aligned with an exterior surface or a door of a vehicle door, to a deployed position, in which the door handle protrudes from the surface of the door of the vehicle door. Further, the handle may be coupled to a latching component that facilitates in latching and unlatching of a vehicle door upon the actuation of the door handle. The door handle is movable to the deployed position, by using an electrical motor or by a mechanical setup, before being manually pulled to unlatch the vehicle door. Additionally, for locking the vehicle door, the locking mechanism (which may be a part of the latching component and such a combination of the locking mechanism and the latching component referred to as a door operation assembly) may be operable, for example, using a key of the vehicle by remotely locking the vehicle in case of a remote keyless entry (RKE)/passive keyless entry (PKE), or by turning the key in case of a manually locking vehicle.

Recently, as an example, the door handle assemblies of various types of vehicles, such as electric vehicles (EVs), may electronically-operated door operation assemblies. For instance, the door operational assemblies may be implemented as an e-latch or with a near-field communication (NFC) combination. The electronically-operated door operation assemblies can be operated by a user to unlock the vehicle using a key fob or a cellular device, such as a mobile phone, as a key. In such cases, the unlocking of the door allows the user to open the door by further unlatching it. In certain other such recently developed door operation assemblies, the unlocking and unlatching/unlatching function of the door is integrated into a single action which can be remotely performed using a key fob or a mobile phone. In other words, the actuation of a button on the key fob or on the mobile phone can trigger the unlocking as well as the unlatching of the door. In such cases, the door handle may be a redundant element on the vehicle door. However, as per regulations, the door handle, although redundant, has to be provided in the door handle assembly vehicles as a failsafe in case of failure of the electronically-operated door operation assembly. Therefore, the provision of door handles on the doors is necessary, even if it is at the cost of redundancy.

Generally, door handles are formed as either protruding from the door, may be disposed of in a door handle recess in the door, or may even be flush with the door, as described above. However, in all such cases, the presence of the door handle makes the vehicle prone to an incident of unauthorized access or theft. For instance, the presence of a visible door handle on the vehicle provides a vulnerability that any person seeking to gain unauthorized access to the vehicle can exploit, for example, by breaking the lock or maneuvering the lock to unlock the vehicle. Additionally, the presence of the visible door handle may hamper the aesthetic appeal of door of the vehicle.

In other words, the present subject matter seeks to address the issues faced with the conventional vehicle door handle assemblies. For instance, with respect to the aesthetic appeal of the vehicle, where modern vehicles often prioritize sleek and aerodynamic designs. The concealed door handle assembly is designed to be flush with the vehicle's door when not in use, preserving the vehicle's aesthetic integrity. Conventional door handles that protrude from the vehicle's surface can disrupt the smooth lines of the vehicle's exterior, detracting from its aesthetic appeal. Conventional door handles also pose a threat of unauthorized access and theft. In such an instance, visible door handles present a vulnerability that can be exploited by individuals seeking unauthorized access to a vehicle. This can include breaking the lock or manipulating the locking mechanism. Another issue faced is the redundancy in modern vehicles, where with the advent of electronic door operation assemblies, such as those using e-latches or near-field communication (NFC), traditional door handles have become somewhat redundant. However, regulations often require the presence of a manual door handle as a failsafe in case of electronic failure. Further, in case of an electronic or mechanical failure of the primary door operation system, there is a requirement for a mechanical fail-safe, such that the user can still access and operate the vehicle door manually, maintaining functionality and safety. There is a need for a door handle assembly that while maintaining the aesthetic appeal of modern vehicles, also enhances security against unauthorized access, provides a reliable mechanical failsafe, and integrates seamlessly with existing door operation systems without the use of potentially unreliable components. In other words, the core idea of the concealed door handle assembly is to provide a secure, aesthetically pleasing, and reliable means of accessing a vehicle's doors that can seamlessly transition between being completely concealed and fully functional, while also serving as a manual backup to electronic door operation systems.

Examples of the present subject matter relating to a concealed door handle assembly for a door operation assembly of a vehicle, are described herein which seeks to address one or more of the abovementioned issues discussed previously.

In an example, the concealed door handle assembly revolves around the integration of a door handle into a vehicle's door in such a way that it remains hidden as well as flush with the door's surface when not in use, thereby enhancing the vehicle's aesthetic appeal and security. The door handle of the concealed door handle assembly is designed to transition between a concealed (flush) state and an operational (deployed) state, while also serving as a manual failsafe for electronic door operation systems. Mainly, the concealed door handle assembly has concealment and aesthetics, operable coupling with a lockable push-push mechanism, integration with door operation assembly, where the door handle may have multiple operational positions and have multiple electronic and mechanical operations, selective accessibility, and elimination of additional components.

With respect to the concealment and aesthetics of the concealed door handle assembly, the door handle of the present subject matter is designed to be flush with the vehicle's exterior acting as a door lock access panel when not in use to conceal access to the door lock access. The door lock access, which is part of the concealed door handle assembly, is designed to be selectively accessible and is a secondary door lock, in case a primary lock of the vehicle is inaccessible. In the event of an electronic or mechanical failure of the primary door operation system, the concealed door handle assembly serves as a mechanical failsafe. This ensures that users can still access and operate the vehicle door manually, maintaining functionality and safety. The door lock access provides access to the secondary door lock and is selectively accessible, i.e., when accessed by the authorized personnel. It can be configured to include a variety of secure access methods, such as a traditional key, a biometric sensor, or other electronic sensors, ensuring that the vehicle can be accessed by authorized users in various ways.

This concealment of door lock access not only preserves the aesthetic lines of the vehicle but also serves to camouflage the handle, making it invisible to unauthorized persons and reducing the likelihood of theft. By concealing the door handle, the assembly reduces the risk of theft and unauthorized entry, as it remains accessible to authorized users while remaining hidden from unauthorized individuals and does not provide an obvious point of interaction for potential intruders.

In this case, the door handle of the concealed door handle assembly can assume multiple positions: a flush position for concealment of a door lock access, a deployed position for access of the door lock access, and an unlatch position for opening the door. These positions correspond to the various states of the lockable push-push mechanism, which can be in a charged or released condition. Further, the door handle may be operably coupled with a lockable push-push mechanism that allows the handle to transition between its flush and deployed positions. This mechanism is designed to be actuated by a simple push action, which engages the handle and causes it to pivot outwards, becoming accessible for use. The concealed door handle assembly is also connected to the door's operational mechanisms, including locking and latching systems. It is designed to transfer motion to initiate locking and unlocking actions, as well as latching and unlatching actions, ensuring that the door can be securely closed or opened as desired, as will be explained later.

Further, the door handle may be operated mechanically or by an electric actuator, such as an electric motor, providing versatility in operation. This dual-operation capability ensures that the handle can function as a manual failsafe in the event of an electronic system failure. Additionally, the concealed door handle assembly of the present subject matter is designed in a way that it avoids the use of components like springs, which can fail or degrade over time, thus enhancing the reliability and longevity of the door handle assembly. The concealed door handle assembly is designed to work in conjunction with the door operation assembly, ensuring seamless operation between the electronic or mechanical components and the manual door handle mechanism. In essence, the concealed door handle assembly provides a secure, aesthetically pleasing, and reliable means of accessing a vehicle's doors that can seamlessly transition between being completely concealed and fully functional, while also serving as a manual backup to electronic door operation systems.

In another example, the concealed door handle assembly may be camouflaged to merge with other components of the door to seem invisible and can work in conjunction with the door operation assembly of the vehicle door. In an example, the door operation assembly may be electronically-operable. In this example, a door handle may be operable by an electric actuator, for instance, an electric motor, a near-field communication (NFC) mounted behind a handle for door opening for NFC variant vehicles. For instance, the electronically-operable door operational assemblies may be implemented as an e-latch or with a near-field communication (NFC) combination. The electronically-operated door operation assemblies may be operated by a user to unlock the vehicle using a key fob or a cellular device, such as a mobile phone, as a key. However, in other examples, mechanically-operated or those door operation assemblies which are operable by other means are also envisaged as implementations of the present subject matter.

According to an aspect, the concealed door handle assembly includes a housing, a door lock access, a lockable push-push mechanism and a door handle. The door lock access and the lockable push-push mechanism may be mounted on the housing of the concealed door handle assembly.

The door lock access may be selectively accessible to access a secondary door lock of a door of the vehicle. The door lock access may be concealed and the access to the door lock access may be restricted and may only be allowed to authorized personnel/user having access. In an example, the door lock access may provide access to the secondary door lock, where the secondary door lock may be a backup recovery access of the door handle assembly. In case the primary door lock gets jammed or is not in working condition, the secondary door lock may be accessed through the door lock access. In an example, the door lock access may be one of a key-receiving portion, a biometric sensor, and a door request sensor, and the like.

In an example, the lockable push-push mechanism mounted on the housing may be mounted adjacent to the door lock access. In this example the lockable push-push mechanism may also be selectively accessible, as the door lock access, when mounted adjacent to the door lock access on the housing. In another example, the lockable push-push mechanism may be directly mounted on the housing in a manner that a pusher of the lockable push-push mechanism may protrude from the housing, and rest of the components of the lockable push-push mechanism may be mounted on and concealed by the housing. In this example, the pusher may be movable between its two positions or conditions—pushed-in and pushed-out—by providing a push-action a pusher of the lockable push-push mechanism. The lockable push-push mechanism may have a plurality of positions.

The door handle may be connected to the housing via a pivot pin. In one example, the door handle can be mounted on a window waist seal area of a door. The door handle is hereinafter interchangeably referred to as the handle. The window waist seal area of the door may be the area on the window frame accommodating a glass on which a window waist seal is provided, such that the window waist seal may wipe the glass as the glass on the window of the door is moved up and down. The handle may camouflage to merge with the window waist seal area to seem invisible.

The concealed door handle assembly of the present subject matter is designed in a manner that the lockable push-push mechanism may be operably coupled to the handle. The handle may be pivotably connected to the housing, where the handle may be a door lock access panel pivoted on the housing about a door handle axis parallel to a plane of the housing for the door handle selectively concealing the door lock access.

In an example, the door handle may be operably coupled to the lockable push-push mechanism to actuate and be actuated by the lockable push-push mechanism. The door handle may have a plurality of operational positions corresponding to the plurality of positions of the lockable push-push mechanism. The door handle may have a plurality of operational positions including a flush position, a deployed position, an unlatch position, and the like. The handle and the lockable push-push mechanism may be operably coupled as such that the handle of the concealed door handle assembly, in flush or undeployed condition, may cover and conceal to restrict access to the door lock access. Therefore, in an instance, where the handle i.e., in flush or undeployed condition, is accessed or actuated by the user to move to the undeployed condition to access the door lock access, the handle may also actuate the lockable push-push mechanism. In this example, the lockable push-push mechanism is movable between its two positions or conditions—pushed-in and pushed-out—by providing a push-action to the pusher of the lockable push-push mechanism. The handle concealing the door lock access may also conceal the lockable push-push mechanism.

The handle may be pivotably mounted to the door through the pivot pin and may be movable between a different plurality of operational positions, such as a flush or undeployed position to a deployed position. In the undeployed condition, the handle can be flush with and camouflaged as the window waist seal on the door. In said example, the handle, in the flush condition or the undeployed condition, may cover and conceal the door lock access mounted on the housing. Therefore, the handle in flush or undeployed condition may also serve as a door lock access panel. In the deployed condition, the handle i.e., pivotably mounted to the housing through the pivot pin may pivot and may be easily accessed by a user. In the deployed condition, the handle may be moveable, such that the door lock access mounted on the housing may be easily accessed by the user to unlock or de-latch the door. In an instance, the door moved to the deployed condition, the handle may actuate thereby allowing the user to access the door lock access, and therefore, the handle may serve as the door lock access panel. The door operation assembly as illustrated above may also be operably mounted on the housing and the components of the concealed door handle assembly for effective and efficient door operations. In one case, the locking mechanism may be in an operable connection with the door lock access, such that the locking action may be initiated by accessing the door lock access, when accessible. Once the locking action has been initiated after accessing the door lock access to unlock the door, the latching action may be done.

In one example, the handle can be movable between the deployed and undeployed position without utilizing an electric mechanism, such as a motor and, instead, can be actuated by means of a simplified mechanical assembly. In another example, the door handle may be operable by an electric actuator, such as an electric motor.

The housing of the concealed door handle assembly may be operably connected to the door operation assembly. The door operation assembly may include a locking mechanism and a latching mechanism. The door operation assembly may include a latch, a link rod and a de-latch cable. In an example, the locking mechanism may include an operation of locking and unlocking by transfer of motion between a latch and a link rod. The locking action may be initiated through the door lock access, where the link rod operably connected to the door lock may transfer motion from the door lock access to the latch to initiate the locking action.

On the other hand, the latching mechanism of the door operation assembly may initiate a latching action. Further, the latching mechanism may include an operation of latching and unlatching by transfer of motion between the latch and the de-latch cable. The latching action may be initiated through the concealed door handle assembly, where the de-latch cable may be operably connected to the door handle assembly transfers motion of movement of the door handle assembly to the unlatch position to the latch to initiate the latching action.

In an example, the door lock access concealed by the handle of the concealed door handle assembly may be connected to the door operation assembly via a link rod and a de-latch cable. As mentioned above, the door operation assembly may include the latch, the link rod and the de-latch cable. The door operation assembly may be operably connected to the concealed door handle assembly. In an instance, the door lock access on the housing of the concealed door handle assembly is accessed through the door handle, the door operation assembly connected to the concealed door handle assembly may unlock the door. The locking mechanism may include the door lock access and the link rod, and may initiate the locking action by accessing the door lock access, to cause the link rod to transfer motion from the door lock access to the latch to initiate unlock action.

In another example, the door operation assembly may have the latching mechanism. The latching mechanism may include the door lock access, door lock access panel and the de-latch cable. In this example, the link rod and the de-latch cable may transfer the motion between the handle and the lockable push-push mechanism to the latch to initiate the latching action.

In an example, the door operation assembly may be electronically-operated, such that the door operation assembly may be operable by a motor coupled to a controller. In other example, the door operation assembly may also be mechanically operable, in case the failsafe option is to be exercised, in case of failure of the primary lock access that may be the electronically-operated door operation assembly.

In operation, the handle may initially be in flush condition, that is when the door handle may conceal the door lock access and restrict locking action, and the handle may be pushed to deploy. As soon as the handle is pushed, the lockable push-push mechanism concealed behind the handle i.e., flushed and camouflaged to the door and in a lock position may be caused to move in. In an example, the lockable push-push mechanism in the concealed door handle assembly may be positioned in a vertical direction and, when pushed, may be released from a charged position and may move to, in turn, push the door in the reverse direction (from the direction of push from the door). In this manner, the door may move to the deployed position. In other words, the door handle in the flush position on receiving an external force transfers force to the lockable push-push mechanism in a charged position to cause the lockable push-push mechanism to counter-push the door handle to move to the deployed position to allow access to the door lock access to initiate locking action and to move the lockable push-push mechanism to released position. As a result, the handle in the deployed position unconceals access to the door lock access.

According to an aspect of the present subject matter, the user on pushing the handle may cause the handle to deploy and pivot along the pivot pin. Once the handle is deployed, the user may be able to access the door lock access and the handle.

From the deployed position, the user may access the door lock access to unlock the door. The door lock access may be one of a key-receiving portion, the biometric sensor, a door request sensor, a request back up sensor, and the like. In an example, to unlock the key-receiving door lock access, a key of the vehicle of the vehicle. In another, to unlock the biometric sensor, the authorized personnel/user may unlock by providing biometric required input, such as thumb impression, retina scan, face identification, and the like. As soon as the door is unlocked through the locking action, the handle can be pulled away from the door to unlatch and open the door. The handle may engage with the latch of the door operation assembly through the de-latch cable to transfer motion of the door to the latch. When so moved, the handle operates the door operation assembly causing the door to be unlatched so that the door can be opened to access the vehicle cabin. Such a position of the handle, where it is pulled further away from the door from the deployed position to unlatch the door, is referred to as the unlatched position of the handle. In an example, the door may be unlatched as the handle moves further from the deployed position.

Upon movement of the handle from the deployed to the unlatched position, the handle may cause the lockable push-push mechanism in released condition to be brought in to the recharged condition where it is locked, i.e., in the same position as the initial position when the handle is deployed. With the lockable push-push mechanism in the recharged condition, when the handle is released, it is brought into the deployed condition and can simply be pushed from the deployed to the flush position.

In the manner described above, the lockable push-push mechanism may be operable in connection with the handle—to cause actuation of the lockable push-push mechanism when operated by the door lock access panel i.e., the door handle concealing the door lock access, and also to be actuated by the lockable push-push mechanism to operate and move the handle into various positions as stated above.

In view of the above, the concealed door handle assembly is implemented through a series of innovative design features and mechanisms that work in concert to provide a seamless and integrated solution. The concealed door handle assembly includes a housing, the lockable push-push mechanism, the door operation assembly, door lock access and door handle. The housing of the concealed door handle assembly may be mounted on the vehicle's door. The door handle that acts as a door lock access panel may be pivotably connected to this housing via the pivot pin, allowing it to move between positions. The door handle is capable of adopting various operational positions, each corresponding to a different state of the lockable push-push mechanism. These include the flush position for concealment, the deployed position for access, and the unlatch position for opening the door. When not in use, the handle remains flush with the door's surface, concealed within the housing, and in line with the vehicle's exterior for aesthetic appeal and to deter unauthorized access concealing the door lock access and maintaining the vehicle's sleek exterior. Further, the lockable push-push mechanism may be integral to the concealed door handle assembly and may be coupled to the door handle in a manner that the lockable push-push mechanism may enable the door handle to transition between its concealed and operational states. This mechanism has multiple positions and is actuated by a simple push action, which engages the door handle and causes it to pivot outwards from the housing, thus becoming accessible for use and also revealing the door lock access for user interaction. The door operational assembly includes a locking mechanism and a latching mechanism, where the locking mechanism facilitates a locking action to lock or unlock the door, whereas the latching mechanism facilitates a latching action to latch or unlatch the door. These mechanisms facilitate locking and unlocking, as well as the latching and unlatching of the door, through mechanical linkages such as a link rod, a de-latch cable and a latch. The door operational assembly includes the link rod, the de-latch cable and the latch, which in connection with the door handle and the door lock access facilitates one of the latching action and locking action.

Through these design features, the concealed door handle assembly effectively implements the core idea, providing a solution that is secure, aesthetically pleasing, and reliable, while also serving as a manual backup to electronic door operation systems. The implementation of the features provided by the concealed door handle assembly is realized through a combination of design elements and mechanisms that embody the claimed features of the patent application, which are not limited thereto. The assembly is meticulously engineered to seamlessly integrate into the vehicle's door system, providing a secure and aesthetically pleasing means of entry while maintaining functionality as a manual failsafe.

In view of the above configurations, the concealed door handle assembly in the vehicle may be concealed and unseen, such that the concealed door handle assembly may only be visible to and may be accessed by authorized personnel and therefore, may prevent unauthorized access to the vehicle. The handle of the present subject matter are safe and concealed, such that any unauthorized personnel trying access to the vehicle for example, by breaking the lock or maneuvering the lock to unlock the vehicle, may not be successful at accessing the vehicle. The present subject matter provides a concealed door handle assembly, that is provided in the vehicles as a failsafe in case of failure of the electronically-operated door operation assembly or in case the electronics malfunction and the door is no longer lockable/unlockable and/or latchable/unlatchable using the electronic door operation assembly. Additionally, the presence of the concealed door handle provides an aesthetic appeal to the vehicle.

The above-mentioned configurations do not require the incorporation of a door handle cut-out on the door, thereby increasing the aesthetic appeal of the door of the vehicle. Further, the present subject matter does not use a spring to connect the lockable push-push mechanism and the concealed door handle assembly, as there may be instances where the spring may break or may not work as efficiently as required. The present subject matter provides a door handling assembly, which may be concealed and may be easily accessed in case of mechanical redundancy in the vehicle, by not compromising on the security of the user and aesthetics of the vehicle.

In addition to the above, the door handle in flush condition when not in use preserves the sleek lines of the vehicle's exterior, contributing to a more streamlined and modern appearance. Further, the concealed door handle assembly improves aerodynamics, by eliminating protruding handles, the assembly can potentially reduce aerodynamic drag, which may lead to improved fuel efficiency and reduced wind noise. The concealed door handle assembly also provides increased security, the concealed nature of the handle assembly makes it less apparent to potential thieves, reducing the risk of break-ins and unauthorized access. Additionally, the concealed door handle also addresses the issue of redundancy and reliability, by offering a manual failsafe mechanism for electronic door operation systems, ensuring door access even in the event of electronic failure. Also, the concealed door handle assembly through the door lock access provides versatile access options, the door lock access can be configured with multiple secure entry methods, including mechanical and electronic systems, providing flexibility for user preferences and technological advancements. The concealed door handle assembly has an intuitive operation, where the push-push mechanism allows for an intuitive user experience, where a simple push action deploys the handle for use. Further, the concealed door handle assembly has reduced part complexity, where the absence of components like springs in the lockable push-push mechanism simplifies the assembly, potentially reducing manufacturing costs and maintenance. Also, the concealed door handle assembly has enhanced durability, and the robust design of the pivotable connection and the lockable push-push mechanism may lead to a longer service life and reduced wear over time. The concealed door handle assembly has seamless integration as the assembly is designed to integrate with existing door operation assemblies, allowing for retrofitting or incorporation into new vehicle designs without extensive modifications.

The concealed door handle assembly has a customizable appearance since the handle can be designed to match or complement the vehicle's exterior, allowing for customization and brand differentiation. Also, the concealed door handle assembly's design is adaptable to incorporate future advancements in door operation technology, such as enhanced electronic or biometric systems. The concealed door handle assembly of the present subject matter is designed to comply with safety regulations, as it has the provision of a manual door handle ensuring compliance with safety regulations that may require a mechanical means of door operation.

The mechanical nature of the handle of the concealed door handle assembly provides tactile feedback to the user, confirming successful engagement and operation. The concealed design of the concealed door handle assembly protects the door lock access and handle from environmental factors such as dirt, ice, and debris, which can affect the operation of exposed handles and locks. The concealed door handle assembly of the present subject matter has reduced the risk of accidental snagging, whereas the flush design minimizes the risk of the handle catching on clothing, bags, or other objects, which can be a hazard with traditional protruding handles. It also provides improved user experience, since the innovative design of the concealed door handle assembly can enhance the overall user experience, contributing to customer satisfaction and brand loyalty. These technical advantages, derived from the description and claims, as well as those evident to a skilled person, demonstrate the multifaceted benefits inherently contemplated by the concealed door handle assembly.

While the above and the description henceforth are provided with respect to a concealed door handle assembly which is provided on an exterior of the door, i.e., an outside concealed door handle assembly, the concepts and aspects described herein are equally applicable mutatis mutandis to inside door handle assemblies also.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

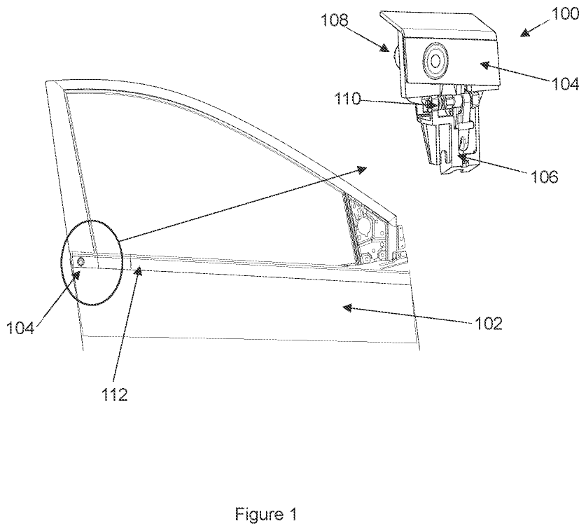

FIG. 1 illustrates a door accommodating a concealed door handle assembly 100, according to an example of the present subject matter.

According to aspects of the present subject matter, the concealed door handle assembly 100 can be so designed that in a locked state of the vehicle, the concealed door handle assembly 100 may be camouflaged to merge with other components of the door 102 to seem invisible and can work in conjunction with the door operation assembly (not shown) of the vehicle door 102.

According to an aspect, the concealed door handle assembly 100 includes a housing 106, a door lock access (not shown), a lockable push-push mechanism 108 and a door handle 104. The door lock access and the lockable push-push mechanism 108 may mounted on the housing 106 of the concealed door handle assembly 100. The door handle 104 is hereinafter interchangeably referred to as the handle 104.

The door lock access may be selectively accessible to access a secondary door lock of a door of the vehicle. The door lock access may be concealed and the access to the door lock access may be restricted and may only be allowed to authorized personnel/users having access. In an example, the door lock access may provide access to the secondary door lock, where the secondary door lock may be a backup recovery access of the door handle assembly. In case the primary door lock gets jammed or is not in working condition, the secondary door lock may be accessed through the door lock access. In an example, the door lock access may be one of a key-receiving portion, a biometric sensor, and a door request sensor, and the like. In an example, the primary door lock is electronically-operated door lock and the second door lock is a mechanically operated door lock. In another example, the primary door lock and the secondary door lock are electronically-operated door locks.

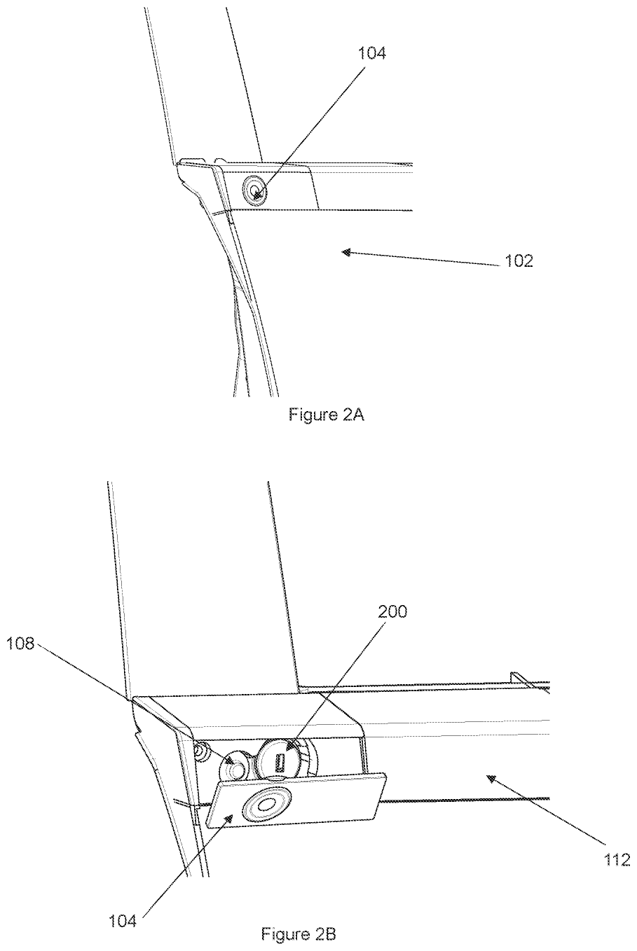

In an example, the lockable push-push mechanism 108 mounted on the housing 106 may be mounted adjacent to the door lock access (as illustrated in FIGS. 2A and 2B). In this example the lockable push-push mechanism 108 may also be selectively accessible, as the door lock access, when mounted adjacent to the door lock access on the housing 106.

In another example, the lockable push-push mechanism 108 may be directly mounted on the housing 106 in a manner that a pusher (not shown) of the lockable push-push mechanism 108 may protrude from the housing 106, and rest of the components of the lockable push-push mechanism 108 may be mounted on and covered by the housing 106, such that only pusher may be visible when handle 104 is accessed, as will be explained later. In this example, the pusher may be movable between its two positions or conditions—pushed-in and pushed-out—by providing a push-action a pusher of the lockable push-push mechanism. The lockable push-push mechanism may have a plurality of positions.

The handle 104 may be connected to the housing 106 via a pivot pin 110. In one example, the handle 104 can be mounted on a window waist seal area of a door 102. The window waist seal area of the door may have a window waist seal 112 that may be provided on the window frame accommodating a glass on which the window waist seal 112 is provided, such that the seal may wipe the glass as the glass on the window of the door is moved up and down.

The concealed door handle assembly 100 of the present subject matter is designed in a manner that the lockable push-push mechanism 108 operably coupled to the handle 104. The handle 104 may be pivotably connected to the housing 106, where the handle 104 may be a door lock access panel pivoted on the housing 106 about a door handle axis parallel to a plane of the housing for the door handle 104 selectively concealing and restricting access the door lock access.

In an example, the door handle 104 may be operably coupled to the lockable push-push mechanism 108 to actuate and be actuated by lockable the push-push mechanism 108. The door handle 104 may have a plurality of operational positions corresponding to the plurality of positions of the lockable push-push mechanism 108. The door handle 104 may have a plurality of operational positions including a flush position, a deployed position, an unlatch position, and the like. The handle and the lockable push-push mechanism may be operably coupled as such that the handle of the concealed door handle assembly, in flush or undeployed condition, may cover and conceal to restrict access to the door lock access, as illustrated in FIG. 1.

The handle 104 may camouflage to merge with the window waist seal area and may be invisible, in a locked state i.e., when the handle 104 is in flush condition. In this locked state, the door may be locked and the handle 104 may not be visible to the user. In this example, the handle 104 may be in-line with the window waist seal 112 of the door 102 when the concealed door handle assembly 100 is undeployed and in flush condition, as illustrated in FIG. 1. In an example, the handle 104 in flush condition, when the vehicle is in the locked state, may cover and conceal the lockable push-push mechanism 108 and the door lock access (not shown in FIG. 1) that is mounted on the housing 106.

In one example, the handle 104 can be movable between the deployed and undeployed position without utilizing an electric mechanism, such as a motor and, instead, can be actuated by means of a simplified mechanical assembly. In another example, the handle 104 may be operable by an electric actuator, such as an electric motor. This will be explained later in respect of FIGS. 2A and 2B.

FIG. 2A illustrates the concealed door handle assembly 100 in a flush position, according to an example of the present subject matter. FIG. 2B illustrates the concealed door handle assembly 100 in a deployed position, according to an example of the present subject matter. FIGS. 2A-2B have been explained in conjunction with each other.

According to an aspect, the handle 104 may be pivotably mounted to the housing 106 through the pivot pin 110 and may be movable between a flush or undeployed position to a deployed position.

In the undeployed condition, as illustrated in FIG. 2A, the handle 104 can be flushed with and camouflaged as the window waist seal 112. In said example, the handle 104, in the flush condition or the undeployed condition, may cover and conceal the lockable push-push mechanism 108 and door lock access 200 mounted on the housing 106. In this example, the lockable push-push mechanism 108 and the door lock access 200 may be mounted adjacent to each other on the housing 106. Therefore, the handle 104 in flush or undeployed condition may also serve as a door lock access panel, that may pivot about its axis when accessed to unconceal access to the door lock access.

According to aspects of the present subject matter, the concealed door handle assembly 100 includes the lockable push-push mechanism 108 operably coupled to the handle 104. The handle 104 and the lockable push-push mechanism 108 may be operably coupled as such that the handle 104 of the concealed door handle assembly, in flush or undeployed condition, may cover and conceal the lockable push-push mechanism 108. Therefore, in an instance, where the handle i.e., in flush or undeployed condition, is accessed or actuated by the user to move to the undeployed condition, the handle 104 may also actuate the lockable push-push mechanism 108. In this example, the lockable push-push mechanism 108 is movable between its two positions or conditions—pushed-in and pushed-out—by providing a push-action a pusher of the lockable push-push mechanism 108. The handle 104 concealing the door lock access 200 may also conceal the lockable push-push mechanism 108.

In operation, the handle 104 may initially be in flush condition, as illustrated in FIG. 2A, and may be pushed to deploy. As soon as the handle 104 is pushed, the lockable push-push mechanism 108 concealed behind the handle 104 may be caused to move in. In an example, the lockable push-push mechanism 104 in the door handle assembly 100 may be positioned in a vertical direction and, when pushed, may be released from a charged position and may move to, in turn, push the handle 104 in the reverse direction (from the direction of push from the handle). In this manner, the door handle may move to a deployed position, as illustrated in FIG. 2B. In other words, the door handle 104 in the flush position on receiving an external force transfers force to the lockable push-push mechanism 108 in a charged position to cause the lockable push-push mechanism 108 to counter-push the door handle 104 to move to the deployed position to allow access to the door lock access 200 to allow initiation of a locking action, as will be explained later and to move the lockable push-push mechanism to released position. As a result, the handle in the deployed position unconceals access to the door lock access.

In the deployed condition, as illustrated in FIG. 2B, the handle 104 i.e., pivotably mounted to the housing through the pivot pin 110 may pivot and may be easily accessed by the user. In the deployed condition, the handle 104 may be moveable, such that the door lock access 200 mounted on the housing 106 may be easily accessed by the user to unlock or unlatch the door 102.

In one example, the handle 104 can be movable between the deployed and undeployed position without utilizing an electric mechanism, such as a motor and, instead, can be actuated by means of a simplified mechanical assembly. In another example, the handle 104 may be operable by an electric actuator, such as an electric motor.

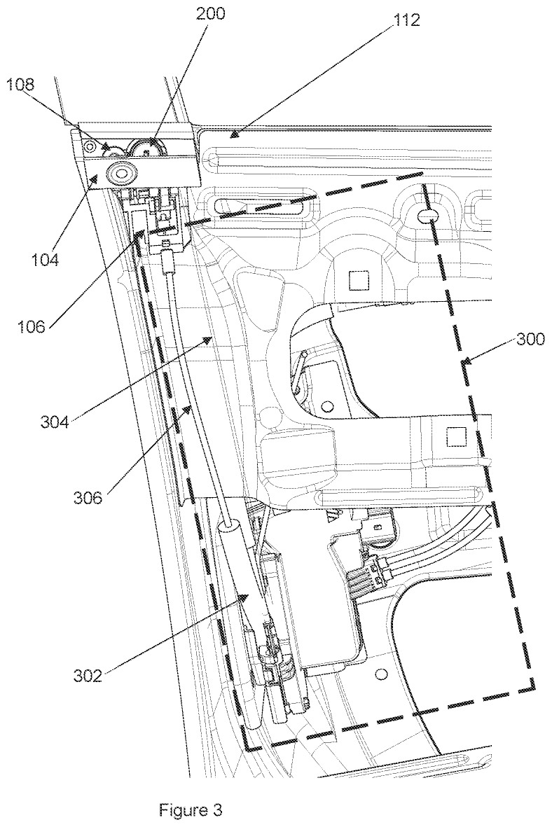

FIG. 3 illustrates a perspective view of the concealed door handle assembly 100 in the door 102, according to an example of the present subject matter.

According to an example, the housing 106 of the concealed door handle assembly 100 may be operably connected to the door operation assembly 300. In an example, the door lock access 200 concealed by the handle 104 of the concealed door handle assembly 100 may be connected to the door operation assembly 300.

The door operation assembly 300 may include a locking mechanism and a latching mechanism. The door operation assembly 300 may include a latch 302, a link rod 304 and a de-latch cable 306. In an example, the locking mechanism may include an operation of locking and unlocking of the door by transfer of motion from a door lock access through the link rod 304 to the latch 302. The locking action may be initiated through the door lock access 200, where the link rod 304 operably connected to the door lock access 200 may transfer motion from the door lock to the latch 302 to initiate the locking action.

On the other hand, the latching mechanism of the door operation assembly 300 may initiate a latching action. Further, the latching mechanism may include an operation of latching and unlatching by transfer of motion from the handle 104 through the de-latch cable 306 to the latch 302. The latching action may be initiated through the concealed door handle assembly 100, where the de-latch cable 306 may be operably connected to the door handle 104 transfers the motion of movement of the door handle 104 to the unlatch position to the latch 302 to initiate the latching action, as will explained.

The door operation assembly 300 may be operably connected to the concealed door handle assembly 100. In this example, the door lock access 200 concealed by the handle 104 of the concealed door handle assembly 100 may be connected to the door operation assembly 300 through the link rod 304 and the de-latch cable 306.

In an example, the link rod 308 may transfer the motion from the door lock access 200 when unconcealed to allow access to the latch 302 to initiate unlatch action. The link rod 304 may transfer the motion to the latch 302 to unlock the door 102. In an example, the de-latch cable 306 may transfer the motion between the handle 104 and the lockable push-push mechanism 108 to the latch 302 to initiate unlock action. The de-latch cable 306 may transfer the motion to the latch 302 to de-latch the door.

From the deployed position, the user may access the door lock access 200 to unlock the door of the vehicle. In an example, the door lock access 200 may be one of a key-receiving portion, the biometric sensor, a door request sensor, a request back up sensor, and the like. In an example, to unlock the key-receiving door lock access, a key of the vehicle of the vehicle. In another, to unlock the biometric sensor, the authorized personnel/user may unlock by providing biometric required input, such as thumb impression, retina scan, face identification, and the like. As soon as the door is unlocked through the locking action, the handle 104 can be pulled away from the door 102 to unlatch and open the door 102. The door lock access 200 may engage with the latch 302 of the door operation assembly 300 through the de-latch cable 306 and the link rod 304 to transfer motion of the handle 104 to the latch 302. When so moved, the handle 104 operates the door operation assembly 300 causing the door 102 to be unlatched so that the door 102 can be opened to access the vehicle cabin. Such a position of the handle 104, where it is pulled further away from the door 102 from the deployed position to unlatch the door 102, is referred to as the unlatched position of the handle 104. In an example, the door 102 may be unlatched as the handle 104 moves further from the deployed position.

Upon movement of the handle 104 from the deployed to the unlatched position, the handle 104 may cause the lockable push-push mechanism 108 in the released condition to be brought into the recharged condition where it is locked, i.e., in the same position as the initial position when the handle 104 is deployed. With the lockable push-push mechanism 108 in the recharged condition, when the handle 104 is released, it is brought into the deployed condition and can simply be pushed from the deployed to flush condition.

In view of the above configurations, the concealed door handle assembly in the vehicle may be concealed and unseen, such that the concealed door handle assembly may only be visible to and may be accessed by authorized personnel and therefore, may prevent unauthorized access to the vehicle. The handles of the present subject matter are safe and are concealed, such that any unauthorized personnel trying access to the vehicle for example, by breaking the lock or maneuvering the lock to unlock the vehicle, may not be successful at accessing the vehicle. The present subject matter provides a concealed door handle assembly, that is provided in the vehicles as a failsafe in case of failure of the electronically-operated door operation assembly or in case the electronics malfunction and the door is no longer lockable/unlockable and/or latchable/unlatchable using the electronic door operation assembly. Additionally, the presence of the concealed door handle provides an aesthetic appeal of the vehicle.

The above-mentioned configurations do not require the incorporation of a door handle cut-out on the door, thereby increasing the aesthetic appeal of the door of the vehicle. Further, the present subject matter does not use spring to connect the lockable push-push mechanism and the concealed door handle assembly, as there may be instances where the spring may break or may not work as efficiently as required. The present subject matter provides a door handling assembly, which may be concealed and may be easily accessed in case of mechanical redundancy in the vehicle, by not compromising on the security of the user and aesthetics of the vehicle.

Although examples for the concealed door handle assembly 100 have been described in language specific to structural features and/or methods, it is to be understood that the appended claims are not limited to the specific features described. Rather, the specific features are disclosed as examples of the concealed door handle assembly 100.

What is claimed is:

1. A concealed door handle assembly (100), the concealed door handle assembly (100) comprising:
a housing (106);
a door lock access (200) mounted on the housing (106), wherein the door lock access (200) is selectively accessible;
a lockable push-push mechanism (108) operably mounted on the housing (106), wherein the lockable push-push mechanism (108) has a plurality of positions to actuate and be actuated;
a door operation assembly (300) operably mounted on the housing (106), wherein the door operational assembly (300) comprises:
a locking mechanism in an operable connection with the door lock access (200) to initiate a locking action; and
a latching mechanism to initiate a latching action; and
a door handle (104) pivotably connected to the housing (106), wherein the door handle (104) is a door lock access panel pivoted on the housing (106) about a door handle axis parallel to a plane of the housing (106) for the door handle (104), wherein the door handle (104) is operably coupled to the lockable push-push mechanism (108) to actuate and be actuated by the lockable push-push mechanism (108), and the door handle (104) has a plurality of operational positions corresponding to the plurality of positions of the lockable push-push mechanism (108),
wherein,
in a flush position, the door handle (104) conceals the door lock access (200) to restrict the locking action,
in a deployed position, the door handle (104) unconceals access to the door lock access (200), wherein the door handle (104) in the flush position on receiving an external force transfers force to the lockable push-push mechanism (108) in a charged position to cause the lockable push-push mechanism (108) to counter-push the door handle (104) to move to the deployed position to allow access to the door lock access (200) to initiate locking action and to move the lockable push-push mechanism (108) to released position, and
in an unlatch position, the door handle (104) is pulled from the deployed position away from the plane of housing (106) to the unlatch position to co-operate with the latching mechanism to initiate the latching action.

2. The concealed door handle assembly (100) as claimed in claim 1, wherein the door lock access (200) is a secondary door lock access and is one of a key-receiving portion, a biometric sensor, and a door request sensor.

3. The concealed door handle assembly (100) as claimed in claim 1, wherein the door operation assembly (300) comprises a latch (302), a link rod (304), and a de-latch cable (306).

4. The concealed door handle assembly (100) as claimed in claim 1, wherein the locking mechanism comprises an operation of locking and unlocking by transfer of motion between a latch (302) and a link rod (304).

5. The concealed door handle assembly (100) as claimed in claim 1, wherein the latching mechanism comprises an operation of latching and unlatching by transfer of motion between a latch (302) and a de-latch cable (306).

6. The concealed door handle assembly (100) as claimed in claim 1, wherein the locking action is initiated through the door lock access (200), wherein a link rod (304) operably connected to the door lock access (200) transfers motion from the door lock access (200) to a latch (302) to initiate the locking action.

7. The concealed door handle assembly (100) as claimed in claim 1, wherein the latching action is initiated through the door handle (104), wherein a de-latch cable (306) is operably connected to the door handle (104) to transfer motion of movement of the door handle (104) to the unlatch position to the latch (302) to initiate the latching action.

8. The concealed door handle assembly (100) as claimed in claim 1, wherein the door handle (104) in the unlatched position causes the lockable push-push mechanism (108) to be recharged to move to the charged condition.

9. The concealed door handle assembly (100) as claimed in claim 1, wherein the door handle (104) is pivotably connected to the housing (106) through a pivot pin (110).

10. The concealed door handle assembly (100) as claimed in claim 1, wherein the door handle (104) is mechanically operated.

11. The concealed door handle assembly (100) as claimed in claim 1, wherein the door handle (104) is operable by an electric actuator, wherein the electric actuator is an electric motor.

12. The concealed door handle assembly (100) as claimed in claim 1, wherein the door operation assembly (300) is electronically operated.

13. The concealed door handle assembly (100) as claimed in claim 1, wherein the door operation assembly (300) is operable by a motor coupled to a controller.

14. The concealed door handle assembly (100) as claimed in claim 1, wherein the door operation assembly (300) is mechanically operated.
